(19) United States
(12) Patent Application Publication
(10) Pub. No.: US 2004/0133330 A1
(43) Pub. Date: Jul. 8, 2004

(54) Self aligning torque reference value calculating apparatus, method thereof, and road surface friction state estimating apparatus, method thereof

(75) Inventors: Eiichi Ono, Toyota-shi (JP); Shoji Inagaki, Toyota-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 10/626,577

(22) Filed: Jul. 25, 2003

(30) Foreign Application Priority Data
Aug. 12, 2002 (JP) 2002-234586

(51) Int. Cl. G06F 17/00

(52) U.S. Cl. 701/80; 73/105

(57) ABSTRACT

A SAT estimating portion obtains an estimated SAT value based on a sum of steering torque and assist torque. A SAT model value calculating portion calculates a SAT model value based on a slip angle. A SAT ratio calculating portion calculates a ratio between the estimated SAT value and the SAT model value. A SAT reference value calculating portion determines that a contact length between a tire and a road surface increases due to an increase in a load of a vehicle or a reduction in a tire pressure, and a SAT inclination increases, and obtains a SAT reference value by upwardly adjusting the SAT model value when a maximum value of the SAT ratio exceeds a threshold value in a predetermined time.

### INCORPORATION BY REFERENCE

The disclosure of Japanese Patent Application No. 2002-234586 filed on Aug. 12, 2002 including the specification, drawings and abstract is incorporated herein by reference in its entirety.

### BACKGROUND OF THE INVENTION

1. Field of the Invention

The invention relates to a self aligning torque reference value calculating apparatus, a method thereof, a road surface friction state estimating apparatus, and a method thereof. More particularly, the invention relates to a self aligning torque reference value calculating apparatus which estimates a self aligning torque reference value used as a reference for estimating a road surface friction state, a method thereof, and a road surface friction state estimating apparatus, and a method thereof.

2. Description of the Related Art

As related art of the invention, Japanese Patent Application No. 2001-212683 discloses a technology for estimating a grip state using self aligning torque (hereinafter, referred to as “SAT”). In the technology, a SAT reference value is calculated based on a front wheel slip angle, an estimated SAT value is calculated by removing friction of a steering system from a sum of torque supplied by a driver and assist torque applied to a power steering device, and a grip state is estimated based on a ratio between the SAT reference value and the estimated SAT value.

Meanwhile, when a superimposed load of a vehicle increases and accordingly a load of a front wheel increases, or when an air pressure of the front wheel decreases, a contact length between a tire and a road surface increases, and as a result, an inclination of SAT with respect to the slip angle increases. However, in the related art, the grip state is estimated using the SAT reference value which is based only on the slip angle, without considering a change in the contact length between the tire and the road surface. Therefore, the grip state cannot be accurately estimated.

### SUMMARY OF THE INVENTION

In order to solve the aforementioned problem, the invention is proposed. Accordingly, it is an object of the invention to provide a self aligning torque reference value calculating apparatus which accurately calculates a SAT reference value used as a reference for estimating a road surface friction state even when a contact length between a tire and a road surface, and a road surface friction state estimating apparatus which estimates a road surface friction state using the SAT reference value.

A self aligning torque reference value calculating apparatus according to a first aspect of the invention includes a self aligning torque estimating portion which estimates self aligning torque applied to a tire; a slip angle estimating portion which estimates a slip angle of the tire; a self aligning torque model value calculating portion which calculates a self aligning torque model value using the slip angle estimated by the slip angle estimating portion; a self aligning torque ratio calculating portion which calculates a self aligning torque ratio which is a ratio between the self aligning torque estimated by the self aligning torque estimating portion and the self aligning torque model value calculated by the self aligning torque model value calculating portion; and a self aligning torque reference value calculating portion which calculates a self aligning torque reference value based on the self aligning torque ratio and the self aligning torque model value when a maximum value of the self aligning torque ratio exceeds a threshold value.

The self aligning torque estimating portion estimates self aligning torque generated in the tire. The invention is not limited to a specific method of estimating self aligning torque. The slip angle estimating portion estimates a slip angle of the tire.

The self aligning torque model value calculating portion calculates, using the slip angle estimated by the slip angle estimating portion, a self aligning torque model value of a model which is made on the assumption that a contact length is a nominal contact length used as a reference for design and a grip degree is high, that is, a linear model which is made linear using a slip angle 0. The self aligning torque model value is a value that is calculated using only the slip angle as a parameter, without considering a change in a road surface friction state, for example, a change in the contact length between the tire and the road surface.

The self aligning torque ratio calculating portion calculates the self aligning torque ratio which is the ratio between the self aligning torque and self aligning torque model value. When the contact length between the tire and the road surface remains the same as in an initial state, the self aligning torque ratio remains the same. However, when the contact length is changed, the self aligning torque is changed, and further, the self aligning torque ratio is changed.

The self aligning torque reference value calculating portion calculates, based on the self aligning torque ratio and the self aligning torque model value, the self aligning torque reference value used as a reference for estimating a road surface friction state when the maximum value of the self aligning torque ratio exceeds the threshold value.

Thus, according to the first aspect of the invention, when the maximum value of the self aligning torque ratio is changed in accordance with a change in the contact length between the tire and the road surface, the self aligning torque reference value is calculated based on the self aligning torque ratio and the self aligning torque model value, thereby obtaining the optimum self aligning torque reference value in accordance with the contact length between the tire and the road surface.

Also, in the first aspect of the invention, the self aligning torque reference value calculating portion may output the self aligning torque model value as the self aligning torque reference value when the maximum value of the self aligning torque ratio does not exceed the threshold value.

When the maximum value of the self aligning torque ratio does not exceed the threshold value, the contact length between the tire and the road surface remains the same. Therefore, the self aligning torque reference value may output, as the self aligning torque reference value, the self aligning torque model value of the linear model which is made on the assumption that the contact length is the nominal contact length. Thus, after it is determined whether or not the contact length between the tire and the road surface is changed by comparing the maximum value of the self aligning torque ratio with the threshold value, it is possible to obtain the self aligning torque reference value in the case where the contact length is not changed.

Also, the self aligning torque reference value calculating apparatus according to the first aspect of the invention may further include a high pass filter which performs high pass filter processing on the slip angle estimated by the slip angle estimating portion; a lateral force calculating portion which calculates a lateral force; a slip angle converting portion which converts the lateral force calculated by the lateral force calculating portion into a slip angle; a low pass filter which performs low pass filter processing on the slip angle obtained by conversion by the slip angle converting portion; and a summing portion which sums the slip angle on which the high pass filter processing has been performed by the high pass filter and the slip angle on which the low pass filter processing has been performed by the low pass filter. In the apparatus, the self aligning torque model value calculating portion may calculate the self aligning torque model value based on the slip angle obtained by summation by the summing portion.

The high pass filter performs the high pass filter processing on the slip angle estimated by the slip angle estimating portion, thereby removing a drift error contained in the slip angle during running on a bank road, and extracting a high frequency component which does not have a phase lag with respect to the self aligning torque.

The lateral force calculating portion calculates the lateral force generated in the tire. Since there is a substantially linear relation between the lateral force and the slip angle, the slip angle converting portion converts the lateral force into the slip angle based on this relation. The low pass filter performs low pass filter processing on the slip angle obtained by conversion by the slip angle converting portion, thereby removing a variation component such as disturbance noise contained in a high frequency region, and extracting an accurate low frequency component during running on a bank road.

The summing portion sums the slip angle on which the high pass filter processing has been performed and the slip angle on which the low pass filter processing has been performed, thereby obtaining the slip angle which does not have disturbance noise, a drift error, or a phase lag with respect to the self aligning torque.

Accordingly, by calculating the self aligning torque reference value based on the slip angle on which the high pass filter processing has been performed and the slip angle on which the low pass filter processing has been performed, it is possible to calculate the self aligning torque reference value which does not have disturbance noise, a drift error, or a phase lag with respect to the self aligning torque even during running on a straight horizontal road or a bank road.

A road surface friction state estimating apparatus according to a second aspect of the invention includes a self aligning torque estimating portion which estimates a self aligning torque applied to a tire; a slip angle estimating portion which estimates a slip angle of the tire; a self aligning torque model value calculating portion which calculates a self aligning torque model value using the slip angle estimated by the slip angle estimating portion; a self aligning torque ratio calculating portion which calculates a self aligning torque ratio which is a ratio between the self aligning torque estimated by the self aligning torque estimating portion and the self aligning torque model value calculated by the self aligning torque model value calculating portion; a self aligning torque reference value calculating portion which calculates a self aligning torque reference value based on the self aligning torque ratio and the self aligning torque model value when a maximum value of the self aligning torque ratio calculated by the self aligning torque ratio calculating portion exceeds a threshold value; and a road surface friction state estimating portion which estimates a road surface friction state based on the self aligning torque estimated by the self aligning torque estimating portion and the self aligning torque reference value calculated by the self aligning torque reference value calculating portion.

According to the second aspect of the invention, even when the contact length between the tire and the road surface is changed, it is possible to accurately estimate a road surface friction state by using the self aligning torque reference value which is a reference in accordance with a change in the contact length.

Also, the invention is not limited to the first aspect or the second aspect of the invention. The invention can be applied to a method of calculating a self aligning torque reference value or a method of estimating a road surface friction state.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a block diagram showing a configuration of a road surface friction state estimating apparatus according to a first embodiment of the invention;

FIG. 2 is a block diagram showing a functional configuration of an electric control unit (ECU);

FIG. 3 is a chart showing an estimated SAT value with respect to a sum of steering torque and assist torque;

FIG. 4 is a chart showing the estimated SAT value with respect to the sum of the steering torque and the assist torque, for describing a method of removing a hysteresis characteristic;

FIG. 5 is a chart showing a relation between a SAT model value and an estimated SAT value;

FIG. 6 is a block diagram showing a configuration of a road surface friction state estimating apparatus according to a second embodiment of the invention; and

FIG. 7 is a block diagram showing a functional configuration of an ECU according to the second embodiment of the invention.

### DETAILED DESCRIPTION OF THE PREFERRED EMBODIMENTS

Hereinafter, preferred embodiments of the invention will be described in detail with reference to the accompanying drawings.

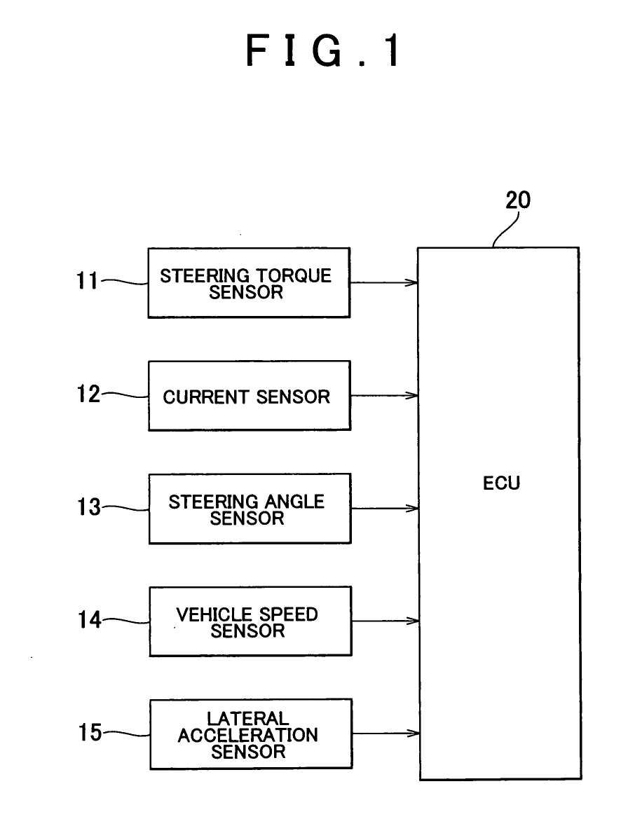

FIG. 1 is a block diagram showing a configuration of a road surface friction state estimating apparatus according to a first embodiment of the invention. The road surface friction state estimating apparatus can be employed, for example, in a vehicle provided with an electric power steering device. Also, the road surface friction state estimating apparatus can be employed in a vehicle provided with a hydraulic power steering device, as described later.

The road surface friction state estimating apparatus includes a steering torque sensor 11 which detects steering torque, a current sensor 12 which detects motor current, a steering angle sensor 13 which detects a steering angle, a vehicle speed sensor 14 which detects a vehicle speed, a lateral acceleration sensor 15 which detects a lateral acceleration, and an electronic control unit (hereinafter, referred to as “ECU”) 20 which estimates a road surface friction state using signals output from the sensors.

The steering torque sensor 11 is disposed coaxially with a steering shaft. The steering torque sensor 11 outputs a sensor signal according to steering torque applied to a steering shaft, and supplies the sensor signal to the ECU 20. The current sensor 12 outputs a sensor signal according to the motor current of an electric motor which is used in the electric power steering device, and supplies the sensor signal to the ECU 20.

The steering angle sensor 13 outputs a sensor signal according to a steering angle θ_{P} due to the driver's steering operation, and supplies the sensor signal to the ECU 20. The vehicle speed sensor 14 outputs a sensor signal according to a vehicle speed (a vehicle body speed) u, and supplies the sensor signal to the ECU 20. The lateral acceleration sensor 15 outputs a sensor signal according to an acceleration in a lateral direction of the vehicle (a lateral acceleration), and supplies the sensor signal to the ECU 20.

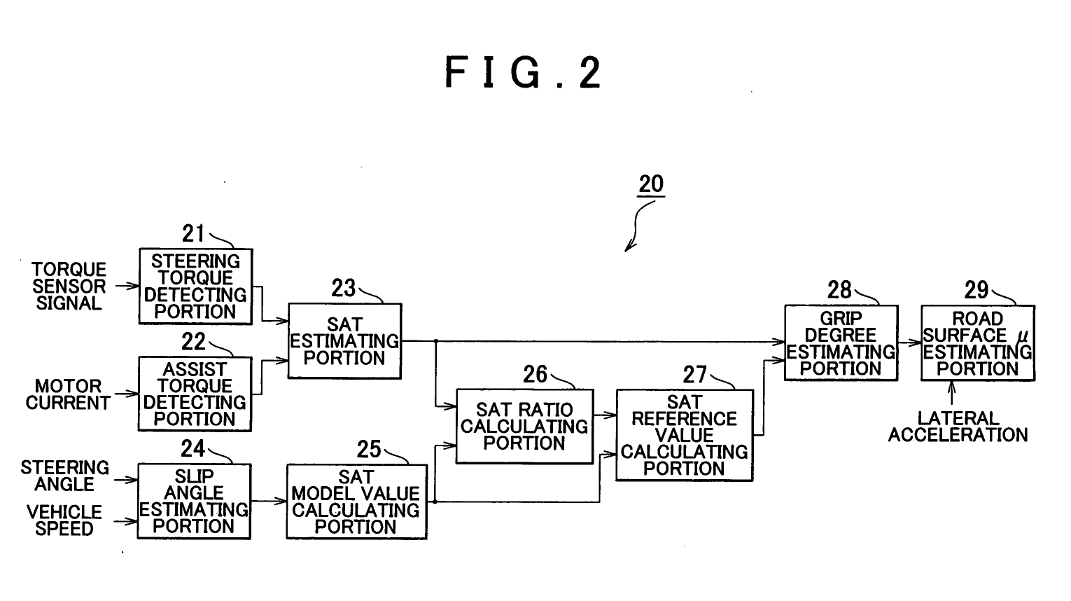

FIG. 2 is a block diagram showing a functional configuration of the ECU 20. The ECU 20 includes a steering torque detecting portion 21 which detects steering torque; an assist torque detecting portion 22 which detects assist torque; a SAT estimating portion 23 which estimates SAT; a slip angle estimating portion 24 which estimates a slip angle; and a SAT model value calculating portion 25 which calculates a SAT model value based on the slip angle.

The ECU 20 further includes a SAT ratio calculating portion 26 which calculates a ratio between the estimated SAT value and the SAT model value; a SAT reference value calculating portion 27 which calculates a SAT reference value; a grip degree estimating portion 28 which estimates a grip degree; and a road surface μ value estimating portion 29 which estimates a road surface friction coefficient (hereinafter, referred to as “a road surface μ value”).

The steering torque detecting portion 21 detects steering torque applied due to the driver's steering operation based on the sensor signal from the steering torque sensor 11, and supplies the detected steering torque to the SAT estimating portion 23.

The assist torque detecting portion 22 detects the assist torque applied to the electric power steering device, based on the motor current based on the sensor signal from the current sensor 12 and a preset parameter (for example, a lead of a pinion, a lead of a ball screw, or an assist motor torque coefficient), and supplies the assist torque to the SAT estimating portion 23. The assist torque detecting portion 22 may use a current command value output to a motor of the electric power steering device, instead of the motor current.

The SAT estimating portion 23 calculates a sum of the steering torque detected by the steering torque detecting portion 21 and the assist torque detected by the assist torque detecting portion 22, thereby estimating SAT generated between a road surface and a tire, while removing friction of a steering system.

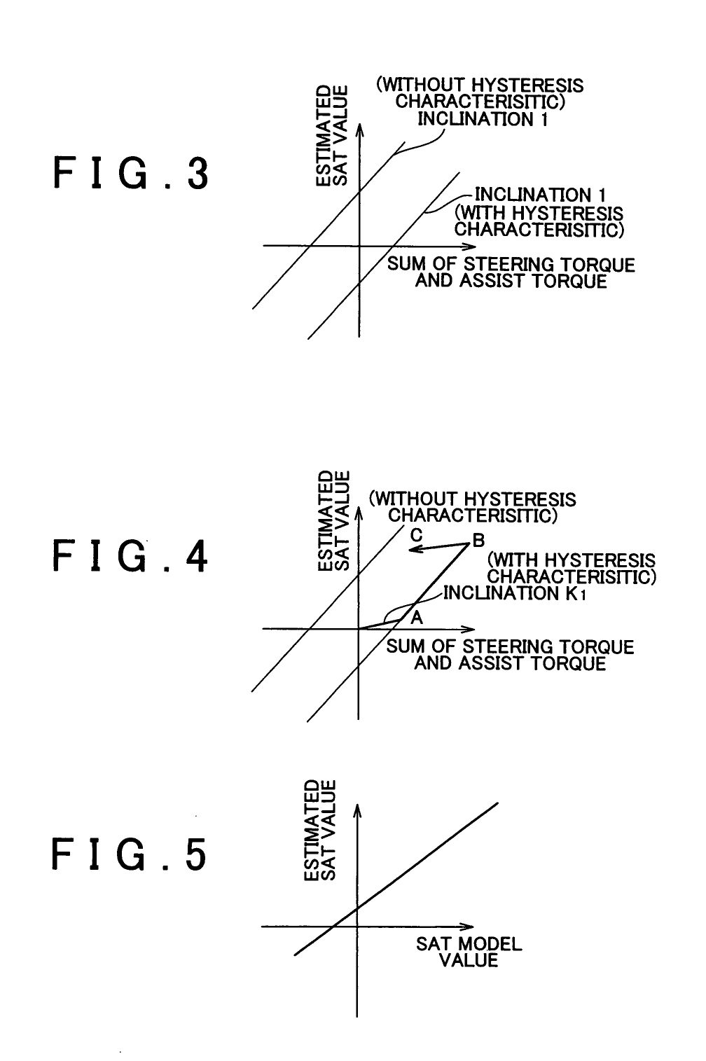

FIG. 3 is a chart showing an estimated SAT value with respect to the sum of the steering torque and the assist torque. A width between two straight lines shows a magnitude of a hysteresis characteristic due to the friction of the steering system. An inclination of each straight line is 1.

FIG. 4 is a chart showing the estimated SAT value with respect to the sum of the steering torque and the assist torque, for describing a method of removing the hysteresis characteristic.

When the sum of the steering torque and the assist torque is 0 and the slip angle is also 0 while the vehicle moves straight, hysteresis does not occur, and the estimated SAT value is 0.

When steering is performed and SAT is generated, the estimated SAT value is calculated using an inclination K₁ with respect to the sum of the steering torque and the assist torque. More specifically, the SAT estimating portion 23 performs a calculation according to the following equation (1) using a discrete logic.

T_{SAT}(k+1)=T_{SAT}(k)+K₁·(T_{DA}(k+1)−T_{DA}(k)) (1)

In the equation, T_{SAT} is the estimated SAT value, T_{DA} is the sum of the steering torque and the assist torque. The inclination K₁ is set to be smaller than 1 in order to indicate that a variation in the estimated SAT value is small even when the sum of the steering torque and the assist torque varies due to Coullomb Friction or the like.

When steering is performed, the estimated SAT value obtained according to the equation (1) reaches a point A in FIG. 4. Further, when the sum of the steering torque and the assist torque increases, the estimated SAT value increases according to a straight line which indicates a lower limit of the model, that is, the estimated SAT value increases according to an equation (2).

T_{SAT}(k+1)=T_{SAT}(k)+T_{DA}(k+1)−T_{DA}(k) (2)

When steering is performed further, the estimated SAT value reaches a point B at which the steering angle stops increasing, and then the sum of the steering torque and the assist torque decreases, the estimated SAT value decreases according to the equation (1) using the inclination K₁. In this region, the estimated SAT value is set such that a variation in the estimated SAT value is small with respect to a variation in the sum of the steering torque and the assist torque. The estimated SAT value is thus set so as not to be influenced by the Coullomb Friction of the power steering device, or the like even if the steering force supplied by the driver varies to a certain degree when the steering angle is maintained while the vehicle is turning.

When the estimated SAT value decreases from the point B to a point C, and then the sum of the steering torque and the assist torque increases, the estimated SAT value increases toward the point B according to the equation (1). Also, when the sum of the steering torque and the assist torque decreases from the point C due to a decrease in the steering angle, and the estimated SAT value reaches an upper limit of the model, the estimated SAT value decreases according to a straight line indicating the upper limit, that is, the estimated SAT value decreases according to the equation (2). Setting two types of inclinations in this way removes the hysteresis characteristic. Then, the SAT estimating portion 23 supplies the estimated SAT value thus obtained to the SAT ratio calculating portion 26 and the grip degree estimating portion 28.

The slip angle estimating portion 24 estimates a front wheel slip angle α_{E}[rad] which is a slip angle of a front tire, based on a steering angle θ_{P}[rad] and a vehicle speed u [m/s]. The steering angle θ_{P} is based on the sensor signal from the steering angle sensor 13, and the vehicle speed u is based on the sensor signal from the vehicle speed sensor 14. The front wheel slip angle α_{E} is represented by state equations (3) and (4), using dynamic characteristics of the vehicle movement.

$$\begin{matrix}\begin{matrix}\frac{ⅆ}{ⅆ t} [ \begin{matrix}v \\ r\end{matrix} ] = ( [ \begin{matrix}0 & - 1 \\ 0 & 0\end{matrix} ] u + \\ [ \begin{matrix}- \frac{{c}_{f} + {c}_{r}}{M} & - \frac{{L}_{f} {c}_{f} - {L}_{r} {c}_{r}}{M} \\ - \frac{{L}_{f} {c}_{f} - {L}_{r} {c}_{r}}{{I}_{z}} & - \frac{{{L}_{f}}^{2} {c}_{f} + {{L}_{r}}^{2} {c}_{r}}{{I}_{z}}\end{matrix} ] / u ) [ \begin{matrix}v \\ r\end{matrix} ] + [ \begin{matrix}\frac{{c}_{f}}{{Mg}_{h}} \\ \frac{{L}_{f} {c}_{f}}{{I}_{z} {g}_{h}}\end{matrix} ] {θ}_{p}\end{matrix} & ( 3 ) \\ {α}_{E} = [ {\begin{matrix}1 & L\end{matrix}}_{f} ] / u [ \begin{matrix}v \\ r\end{matrix} ] - \frac{{θ}_{p}}{{g}_{h}} & ( 4 )\end{matrix}$$

In the equations, v is a lateral speed [m/s], r is a yaw rate [rad/s], u is a vehicle speed [m/s], c_{f} is a front wheel cornering power [N/rad], cᵣ is a rear wheel cornering power [N/rad], L_{f} is a distance between a front axle and a center of gravity of the vehicle [m], Lᵣ is a distance between a rear axle and a center of gravity of the vehicle [m], M is a vehicle mass [kg], I_{Z} is yaw inertia [kgm²], and gₕ is a steering gear ratio.

By making the equations (3) and (4) discrete using a sample time τ, the following equations (5) and (6) are obtained.

$$\begin{matrix}x ( k + 1 ) = ( [ \begin{matrix}1 & 0 \\ 0 & 1\end{matrix} ] + [ \begin{matrix}0 & - τ \\ 0 & 0\end{matrix} ] u ( k ) + τ {A}_{s} / u ( k ) ) x ( k ) + τ {B}_{s} {θ}_{p} ( k ) & ( 5 ) \\ {α}_{E} ( k ) = [ \begin{matrix}1 & {L}_{f} ] x ( k ) / u ( k ) - {θ}_{p} ( k ) / {g}_{h}\end{matrix} & ( 6 )\end{matrix}$$

In the equations, k is a sampling number. Also, Aₛ and Bₛ in the equation (5) are represented by the following equations (7).

$${A}_{s} = [ \begin{matrix}- \frac{{c}_{f} + {c}_{r}}{M} & - \frac{{L}_{f} {c}_{f} - {L}_{r} {c}_{r}}{M} \\ - \frac{{L}_{f} {c}_{f} - {L}_{r} {c}_{r}}{{I}_{z}} & - \frac{{{L}_{f}}^{2} {c}_{f} + {{L}_{r}}^{2} {c}_{r}}{{I}_{z}}\end{matrix} ] , {B}_{s} = [ \begin{matrix}\frac{{c}_{f}}{{Mg}_{h}} \\ \frac{{L}_{f} {c}_{f}}{{I}_{z} {g}_{h}}\end{matrix} ] \qquad ( 7 )$$

The slip angle estimating portion 24 estimates the front wheel slip angle α_{E} by performing calculations according to the equations (5) to (7), and supplies the front wheel slip angle α_{E} to the SAT model value calculating portion 25 every sample time τ.

The SAT model value calculating portion 25 calculates the SAT model value using the front wheel slip angle α_{E}. The SAT model value is the SAT value of a model which is made on the assumption that a contact length is a nominal contact length used as a reference for design and a grip degree is high, that is, a linear model which is made linear using a slip angle 0. More specifically, the SAT model value is obtained by the following equation (8).

Tₘ=K_{O}·α_{E} (8)

In the equation, K_{O} is an inclination of the SAT model value with respect to the front wheel slip angle at a zero point (i.e., a SAT inclination) in the case where there is no change in a load of the vehicle and no reduction in a tire pressure. The SAT model value is represented as a product of the inclination K_{O} and the front wheel slip angle α_{E} as shown in the equation (8). Thus, the SAT model value is a theoretical SAT value in the case where there is no change in the load of the vehicle, no reduction in the tire pressure, and the grip degree is high. The SAT model value calculating portion 25 supplies the SAT ratio calculating portion 26 with the SAT model value which is calculated according to the equation (8).

The SAT ratio calculating portion 26 calculates a SAT ratio (the estimated SAT value/the SAT model value) which is a ratio of the estimated SAT value to the SAT model value, using the estimated SAT value obtained by the SAT estimating portion 23 and the SAT model value calculated by the SAT model value calculating portion 25. The SAT ratio is calculated using an online identification method. More specifically, the SAT ratio is derived according to the equations (9) to (11).

$$\begin{matrix}φ [ k ] = [ \begin{matrix}{T}_{m} [ k ] \\ 1\end{matrix} ] & ( 9 ) \\ φ [ k + 1 ] = θ [ k ] + \frac{P [ k ] φ [ k ]}{λ + {φ [ k ]}^{T} P [ k ] φ [ k ]} ( {T}_{SAT} [ k ] - {φ [ k ]}^{T} θ [ k ] ) & ( 10 ) \\ P [ k + 1 ] = \frac{1}{λ} ( P [ k ] - \frac{P [ k ] φ [ k ] {φ [ k ]}^{T} P [ k ]}{λ + {φ [ k ]}^{T} P [ k ] φ [ k ]} ) & ( 11 )\end{matrix}$$

In the equations, θ is an estimation parameter (a first element: a ratio of the estimated SAT value to the SAT model value, a second element: a drift component generated by a shift in a steering neutral point, and the like), λ is an oblivion coefficient, and k is a sampling number.

FIG. 5 is a chart showing a relation between the SAT model value and the estimated SAT value. In the calculation algorithm for the SAT ratio in the equations (9) to (11), the estimation parameter θ is obtained. In the parameter θ, a first element is an inclination of a straight line shown in FIG. 5, and a second element is an intercept of the straight line. When there is no shift in the steering neutral point, the intercept as the second element is 0.

A change in the load of the vehicle and a reduction in the tire pressure occur slowly as compared with behaviors of the vehicle. Therefore, in the calculation algorithm for the SAT ratio, quick response is not required. Accordingly, it is preferable to obtain the estimation parameter 0 based on a trajectory shown in FIG. 5 in the case where the driver repeats the steering operation several times. In the embodiment, an online least squares method is employed.

The SAT reference value calculating portion 27 calculates a SAT reference value by adjusting the SAT model value calculated by the SAT model value calculating portion 25 as required based on the SAT ratio supplied by the SAT ratio calculating portion 26.

More specifically, the SAT reference value calculating portion 27 determines whether or not a maximum value of the SAT ratio exceeds a threshold value in a predetermined time. When the maximum value of the SAT ratio does not exceed the threshold value in the predetermined time, the SAT reference value calculating portion 27 outputs the SAT model value as the SAT reference value.

Meanwhile, when the maximum value of the SAT ratio exceeds the threshold value in the predetermined time, the SAT reference value calculating portion 27 determines that the contact length between the tire and the road surface increases due to an increase in the load of the vehicle or a reduction in the tire pressure, and the SAT inclination increases. Then, the SAT reference value calculating portion 27 obtains the SAT reference value by adjusting the SAT model value upwardly. For upward adjustment, the following equation (12) is used.

T_{SATOm}=T_{SATO}·γ (12)

In the equation, T_{SATOm} is the SAT reference value, T_{SATO} is the SAT model value before adjustment, and γ is a parameter for upward adjustment and is the maximum value of the SAT ratio in the predetermined time in the embodiment. As the threshold value, for example, “1.2” is used. Considering that the tire pressure is not adjusted during running, γ may be set as a parameter which does not decrease, as long as the vehicle is not stopped for a given time or more. The SAT reference value calculating portion 27 supplies the grip degree estimating portion 28 with the SAT reference value T_{SATmO} thus obtained.

The grip degree estimating portion 28 estimates a grip degree ε according to the following equation (13) based on the estimated SAT value T_{SAT} estimated by the SAT estimating portion 23 and the SAT reference value T_{SATmO} calculated by the SAT reference value calculating portion 27.

$$ϵ = \frac{{T}_{SAT}}{{T}_{{SATO}_{m}}} \qquad ( 13 )$$

The invention is not limited to a configuration in which the grip degree estimating portion 28 estimates the grip degree ε using the aforementioned method. For example, the grip degree ε may be represented using a function of the SAT reference value T_{SATmO} and the estimated SAT value T_{SAT}. Alternatively, the grip degree ε may be represented using a two-dimensional map of the SAT reference value T_{SATmO} and the estimated SAT value T_{SAT}.

The road surface μ value estimating portion 29 estimates a road surface μ value based on the grip degree ε and the lateral acceleration g_{y} when the grip degree ε estimated by the grip degree estimating portion 28 becomes equal to or smaller than a predetermined reference value (for example, when the grip degree ε becomes equal to or smaller than 0.5). The lateral acceleration g_{y} is based on the sensor signal from the lateral acceleration sensor 15.

The road surface μ value is represented by the following equation (14).

$$u = \frac{{g}_{fy}}{( 1 - ϵ ) g} \qquad ( 14 )$$

In the equation, g is a gravitational acceleration. Also, g_{fy} is a front wheel position lateral acceleration, and is represented by the following equation (15).

$${g}_{fy} = \frac{{L}_{r} {g}_{y} + \frac{{I}_{z}}{M} \frac{ⅆ r}{ⅆ t}}{{L}_{f} + {L}_{r}} \qquad ( 15 )$$

The estimation accuracy of the road surface μ value thus obtained is improved as the grip degree ε decreases, that is, the grip degree ε approaches a limit value. Accordingly, when the grip degree ε becomes equal to or smaller than the predetermined reference value as described above, the road surface μ estimating portion 29 estimates the road surface μ value according to the equations (14) and (15).

As described above, the road surface friction state estimating apparatus according to the first embodiment calculates the SAT model value as the SAT reference value, and estimates a road surface friction state based on the SAT reference value and the estimated SAT value when the contact length between the tire and the road surface remains the same as in the initial state.

When the contact length between the tire and the road surface increases due to an increase in the superimposed load of the vehicle or a reduction in the tire pressure, and the inclination of SAT with respect to the slip angle increases, it is possible to calculate the SAT reference value considering the current estimated SAT value in addition to the SAT model value. Thus, it is possible to accurately estimate the grip degree ε equivalent to an excess of a frictional force in the lateral direction as a road surface friction state, according to a change in the contact length between the tire and the road surface. Also, it is possible to accurately estimate the road surface μ value when the grip degree ε becomes equal to or smaller than the reference value.

### Second Embodiment

Next, a second embodiment of the invention will be described. The same portions as in the first embodiment are denoted by the same reference numerals, and duplicate description thereof will be omitted.

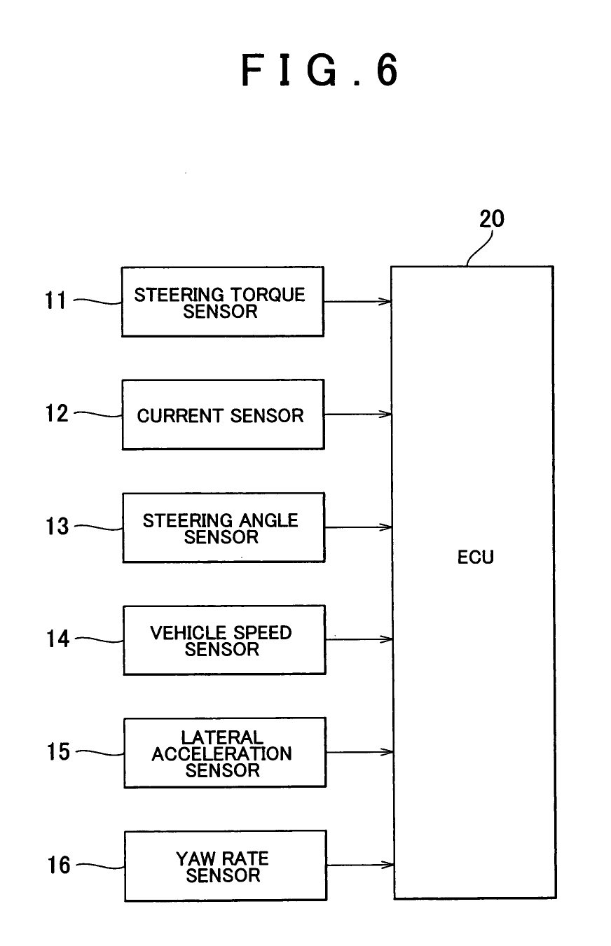

FIG. 6 is a block diagram showing a configuration of a road surface friction state estimating apparatus according to the second embodiment. The road surface friction state estimating apparatus further includes a yaw rate sensor 16 which detects a yaw rate, in addition to the configuration shown in FIG. 1.

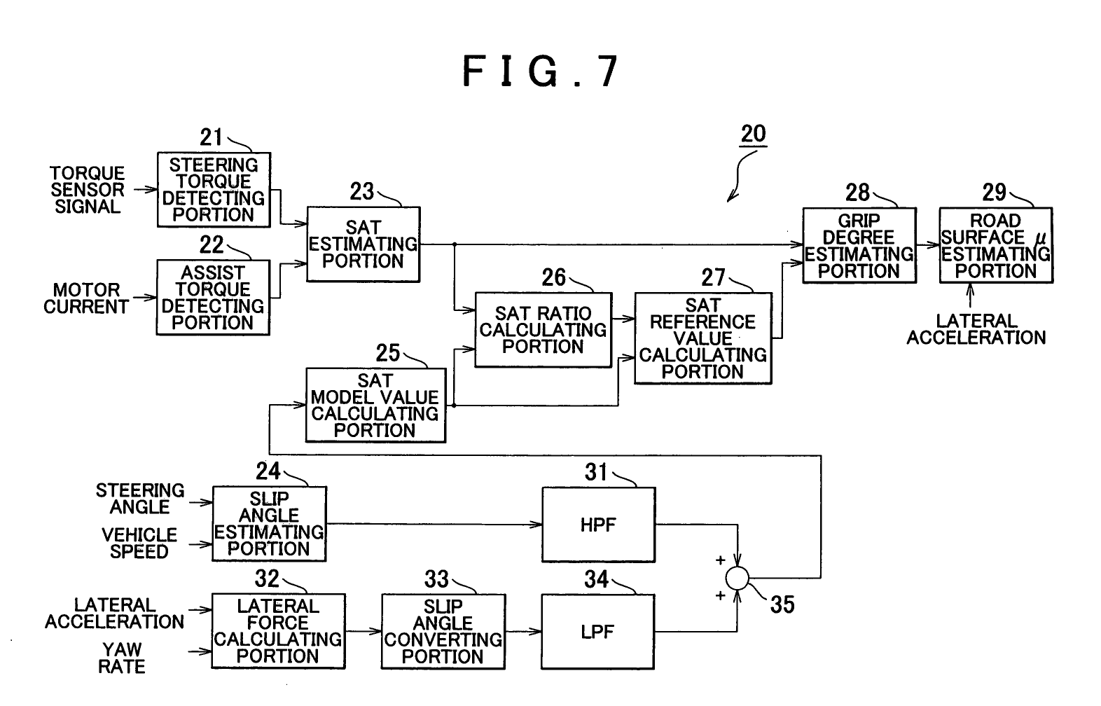

FIG. 7 is a block diagram showing a functional configuration of the ECU 20. In addition to the configuration shown in FIG. 2, the ECU 20 further includes a high pass filter 31 which performs high pass filter processing on the slip angle estimated by the slip angle estimating portion 24; a lateral force calculating portion 32 which calculates a front wheel lateral force of the vehicle; a slip angle converting portion 33 which converts the front wheel lateral force into a slip angle; a low pass filter 34 which performs low pass filter processing on the slip angle obtained by conversion; and a summing device 35 which sums the two slip angles on each of which the filter processing has been performed.

The high pass filter 31 performs high pass filter processing on the front wheel slip angle α_{E} estimated by the slip angle estimating portion 24. When the steering neutral point shifts during running on a bank road, the front wheel slip angle α_{E} estimated by the slip angle estimating portion 24 contains a drift error in a low frequency region, but contains a signal component which does not have a phase lag with respect to the estimated SAT value in a high frequency region. Therefore, the high pass filter 31 removes the drift error in the low frequency region and extracts only the high frequency component which does not have a phase lag with respect to the estimated SAT value, by performing the high pass filter processing on the front wheel slip angle α_{E}.

The high pass filter 31 is configured as a primary discrete filter. The primary high pass filter during a continuous time is represented by the equation (16) which is a transfer function.

$${G}_{H} ( s ) = \frac{s}{s + {ω}_{b}} \qquad ( 16 )$$

In the equation, ω_{b} is a breakpoint frequency. The high pass filter during a discrete time can be designed by transforming the equation (16), for example, by a Tustin transform. In the Tustin transform, when the sampling time is T and a time lead operator is z, a differential sign s is represented by the equation (17).

$$s = \frac{2 ( z - 1 )}{T ( z + 1 )} \qquad ( 17 )$$

By substituting the equation (17) into the equation (16), the high pass filter during a discrete time is represented by the equation (18).

$${G}_{L} ( z ) = \frac{2 ( z - 1 )}{( T {ω}_{b} + 2 ) z + T {ω}_{b} - 2} \qquad ( 18 )$$

The high pass filter 31 performs the high pass filter processing on the front wheel slip angle α_{E} according to the equation (18), and supplies the summing device 35 with the front wheel slip angle α_{E} on which the high pass filter processing has been performed.

The lateral force calculating portion 32 calculates a front wheel lateral force F_{f} which is a lateral force generated in a front tire, using a lateral acceleration g_{y} and a yaw rate r. The lateral acceleration g_{y} is based on the sensor signal from the lateral acceleration sensor 15, and the yaw rate r is based the sensor signal from the yaw rate sensor 16.

The front wheel lateral force F_{f} satisfies the equation of motion (19) concerning the lateral acceleration g_{y}, and satisfies the equation of motion (20) concerning the yaw rate r.

$$\begin{matrix}M ( \frac{ⅆ v}{ⅆ t} + ru ) = {F}_{f} + {F}_{r} & ( 19 ) \\ {I}_{z} \frac{ⅆ r}{ⅆ t} = {L}_{f} {F}_{f} - {L}_{r} {F}_{r} & ( 20 )\end{matrix}$$

In the equations, Fᵣ is a rear lateral force. The lateral acceleration g_{y} is represented by the following equation (21).

$${g}_{y} = \frac{ⅆ v}{ⅆ t} + ru \qquad ( 21 )$$

Based on the equations (19) and (20), the front wheel lateral force F_{f} is represented by the following (22).

$${F}_{f} = \frac{{L}_{r} {Mg}_{y} + {I}_{z} \frac{ⅆ r}{ⅆ t}}{{L}_{f} + {L}_{r}} \qquad ( 22 )$$

The lateral force calculating portion 32 calculates the front wheel lateral force F_{f} using the yaw rate r and the lateral acceleration g_{y} according to the equation (22), and supplies the slip angle converting portion 33 with the front wheel lateral force F_{f}.

The slip angle converting portion 33 converts the front wheel lateral force F_{f} into a front wheel slip angle α_{T} by dividing the front wheel lateral force F_{f} supplied by the lateral force calculating portion 32 by a front wheel cornering power c_{f}. More particularly, the slip angle converting portion 33 performs a calculation according to the following equation (23).

$${α}_{T} = - \frac{{F}_{f}}{{c}_{f}} \qquad ( 23 )$$

The low pass filter 34 performs low pass filter processing on the front wheel slip angle α_{T} calculated by the slip angle converting portion 33. The front wheel slip angle α_{T} calculated by the slip angle converting portion 33 contains, in the high frequency region, a variation component such as noise due to road surface disturbance and a phase lag. However, the front wheel slip angle α_{T} contains the low frequency component which is not influenced by the road surface disturbance even when the vehicle runs on a bank road. Thus, the low pass filter 34 removes the variation component in the high frequency region and extracts only the low frequency component which is accurately calculated, by performing the low pass filter processing on the front wheel slip angle α_{T}.

More specifically, the low pass filter 34 is configured as a primary discrete filter having the same breakpoint frequency as that of the high pass filter 31. The primary low pass filter during a continuous time is represented by the following equation (24) which is a transfer function.

$${G}_{L} ( s ) = \frac{{ω}_{b}}{s + {ω}_{b}} \qquad ( 24 )$$

The low pass filter during a discrete time is obtained by transforming the equation (24) by the Tustin transform, and is represented by the following equation (25).

$${G}_{L} ( s ) = \frac{T {ω}_{b} ( z + 1 )}{( T {ω}_{b} + 2 ) z + T {ω}_{b} - 2} \qquad ( 25 )$$

The low pass filter 34 performs the low pass filter processing on the front wheel slip angle α_{T} according to the equation (25), and supplies the summing device 35 with the front wheel slip angle α_{T} on which the filter processing has been performed.

The invention is not limited to a specific breakpoint frequency. However, the breakpoint frequency is preferably set so as to change in accordance with a road surface cant change speed, that is, a speed at which a cant of the road surface changes, in order to remove noise due to road surface disturbance.

The summing device 35 calculates an integrated slip angle α_{I} by summing the front wheel slip angle α_{E} supplied by the high pass filter 31 and the front wheel slip angle α_{T} supplied by the low pass filter 34. In other words, the summing device 35 performs a calculation according to the following equation (26).

α_{I}=G_{H}(Z)·α_{E}(Z)+G_{L}(Z)·α_{T}(Z) (26)

The sum of the transfer function of the high pass filter 31 and the transfer function of the low pass filter 34 is 1. Therefore, when the same signal is input to the high pass filter and the low pass filter, and outputs of both the filters are summed, the original signal is restored. Accordingly, the summing device 35 can calculate the slip angle α_{I} which is not influenced by a drift error or noise.

The SAT model value calculating portion 25 calculates the SAT model value in the case where there is no change in the load of the vehicle and no reduction in the tire pressure, using the integrated slip angle α_{I} obtained by the summing device 35. More specifically, the SAT model value calculating portion 25 performs a calculation according to the following equation (27).

Tₘ=K_{O}·α_{I} (27)

Thus, the SAT model value calculating portion 25 can accurately calculate the SAT model value in the case where there is no change in the load of the vehicle and no reduction in the tire pressure, without being influenced by a drift error due to a shift in the steering neutral point or noise due to road disturbance or the like during running on a bank road.

The SAT ratio calculating portion 26 calculates the SAT ratio (the estimated SAT value/the SAT model value), using the estimated SAT value obtained by the SAT estimating portion 23 and the SAT model value calculated by the SAT model value calculating portion 25. In the embodiment, the SAT ratio is derived according to the following equations (28) to (30).

$$\begin{matrix}φ [ k ] = {T}_{m} [ k ] & ( 28 ) \\ φ [ k + 1 ] = θ [ k ] + \frac{P [ k ] φ [ k ]}{λ + {φ [ k ]}^{2} P [ k ]} ( {T}_{SAT} [ k ] - θ [ k ] θ [ k ] ) & ( 29 ) \\ P [ k + 1 ] = \frac{1}{λ} ( P [ k ] - \frac{{P [ k ]}^{2} {φ [ k ]}^{2}}{λ + {φ [ k ]}^{2} P [ k ]} ) & ( 30 )\end{matrix}$$

In the equations, θ is an estimation parameter (a ratio of the estimated SAT value to the SAT model value). In other words, only the SAT ratio is used as the estimation parameter θ. Also, P[k] in the equations (29), (30) is a scalar value, while P[k] in the equations (10), (11) in the first embodiment is a matrix with 2 rows and 2 columns.

Thus, according to the embodiment, since the SAT ratio calculating portion 26 does not need to consider a drift error due to a shift in the steering neutral point, a second element of the parameter θ is not required. Therefore, it is possible to greatly reduce a load of the online identification calculation which is performed when calculating the SAT ratio. Each of the SAT reference value calculating portion 27, the grip degree estimating portion 28, and the road surface μ value estimating portion 29 performs the same calculation processing as in the first embodiment.

As described above, the road surface friction state estimating apparatus according to the embodiment can accurately estimate the grip degree ε and the road surface μ value by calculating the SAT reference value T_{SATmO} based on the integrated slip angle which has been extracted by the high pass filter 31 and the low pass filter 34, and calculating the ratio between the SAT reference value T_{SATmO} and the estimated SAT value T_{SAT} estimated by the SAT estimating portion 23.

Particularly, the road surface friction state estimating apparatus can remove a drift error due to a shift in the steering neutral point during running on a bank road, and can accurately estimate a road surface friction state without being influenced by road disturbance, by using the high pass filter 31 and the low pass filter 34. Further, since the road surface friction state estimating apparatus calculates the SAT ratio without considering a drift error, the load of the online identification calculation can be reduced.

The breakpoint frequency of the high pass filter 31 and the low pass filter 34 may be a fixed frequency. However, the breakpoint frequency needs to be set to be equal to or higher than a road surface cant change speed, that is, a speed at which a cant of a road surface changes. The road surface cant change speed is proportional to a vehicle speed. Thus, the high pass filter 31 and low pass filter 34 may be configured such that the breakpoint frequency becomes higher as the vehicle speed becomes higher.

Since the road surface friction state estimating apparatus is provided with the high pass filter 31 and the low pass filter 34 thus configured, the apparatus can accurately estimate a road surface friction state even when the vehicle enters a bank road at a high speed.

Also, the high pass filter 31 and the low pass filter 34 may be configured such that the breakpoint frequency becomes higher as a deviation between the estimated slip angle value α_{E} and the converted slip angle value α_{T} (i.e., the slip angle value α_{T} obtained by conversion) becomes larger. This is because the deviation between the estimated slip angle value α_{E} and the converted slip angle value α_{T} becomes large in the case where the vehicle runs on a bank road, or in the case where the relation between the lateral force and the slip angle becomes non-linear. In such a case, it is preferable to use the converted slip angle value α_{T} which is based on the front wheel lateral force F_{f}. that is not influenced by a change in the steering neutral point or the non-linear relation between the lateral force and the slip angle.

Since the road surface friction state estimating apparatus is provided with the high pass filter 31 and the low pass filter 34, the apparatus can increase a proportion of the converted slip angle value α_{T} based on the front wheel lateral force F_{f} to the estimated slip angle value α_{E} based on the steering angle when using the converted slip angle value α_{T} and the estimated slip angle value α_{E} to obtain the integrated slip angle α_{I}, according to the vehicle movement state. As a result, the road surface friction state estimating apparatus can accurately estimate a road surface friction state, for example, even when the vehicle suddenly enters a bank road, or the vehicle is suddenly brought into a spin state.

The invention is not limited to the aforementioned embodiments, and various modifications can be made to the design within the scope of the invention defined by claims.

For example, in the aforementioned embodiments, the grip degree and the road surface μ value are estimated using the electric power steering device. However, a hydraulic power steering device may be used. When the hydraulic power steering device is used, it is possible to estimate the grip degree and the road surface μ value in the same manner as in the aforementioned embodiments, by measuring a hydraulic pressure and the like of the hydraulic power steering device, and detecting torque corresponding to the steering torque and torque corresponding to the assist torque.

In the aforementioned embodiments, the high pass filter 31 and the low pass filter 34 are represented using the linear transfer functions. However, other functions may be used.

What is claimed is:

1. A self aligning torque reference value calculating apparatus comprising:
a self aligning torque estimating portion which estimates a self aligning torque applied to a tire;
a slip angle estimating portion which estimates a slip angle of the tire;
a self aligning torque model value calculating portion which calculates a self aligning torque model value using the slip angle estimated by the slip angle estimating portion;
a self aligning torque ratio calculating portion which calculates a self aligning torque ratio which is a ratio between the self aligning torque estimated by the self aligning torque estimating portion and the self aligning torque model value calculated by the self aligning torque model value calculating portion; and
a self aligning torque reference value calculating portion which calculates a self aligning torque reference value based on the self aligning torque ratio and the self aligning torque model value when a maximum value of the self aligning torque ratio calculated by the self aligning torque ratio calculating portion exceeds a threshold value.

2. The apparatus according to claim 1, wherein the self aligning torque reference value calculating portion outputs the self aligning torque model value as the self aligning torque reference value when the maximum value of the self aligning torque ratio does not exceed the threshold value.

3. The apparatus according to claim 1, wherein the self aligning torque reference value calculating portion calculates the self aligning torque reference value by summing the self aligning torque ratio and the self aligning torque model value.

4. The apparatus according to claim 1 further comprising:
a high pass filter which performs high pass filter processing on the slip angle estimated by the slip angle estimating portion;
a lateral force calculating portion which calculates a lateral force applied to the tire;
a low pass filter which performs low pass filter processing on the slip angle obtained by conversion by the slip angle converting portion; and
a summing portion which sums the slip angle on which the high pass filter processing has been performed by the high pass filter and the slip angle on which the low pass filter processing has been performed by the low pass filter, wherein the self aligning torque model value calculating portion calculates the self aligning torque model value based on the slip angle obtained by summation by the summing portion.

5. A road surface friction state estimating apparatus comprising:
a self aligning torque estimating portion which estimates a self aligning torque applied to a tire;
a slip angle estimating portion which estimates a slip angle of the tire;
a self aligning torque model value calculating portion which calculates a self aligning torque model value using the slip angle estimated by the slip angle estimating portion;
a self aligning torque ratio calculating portion which calculates a self aligning torque ratio which is a ratio between the self aligning torque estimated by the self aligning torque estimating portion and the self aligning torque model value calculated by the self aligning torque model value calculating portion;
a self aligning torque reference value calculating portion which calculates a self aligning torque reference value based on the self aligning torque ratio and the self aligning torque model value when a maximum value of the self aligning torque ratio calculated by the self aligning torque ratio calculating portion exceeds a threshold value; and
a road surface friction state estimating portion which estimates a road surface friction state based on the self aligning torque estimated by the self aligning torque estimating portion and the self aligning torque reference value calculated by the self aligning torque reference value calculating portion.

6. The apparatus according to claim 5, wherein the road surface friction state estimating portion estimates a grip degree of the tire as the road surface friction state, based on a ratio between the self aligning torque and the self aligning torque reference value.

7. The apparatus according to claim 6, wherein the road surface friction state estimating portion estimates a road surface friction coefficient based on the grip degree and a lateral acceleration.

8. A self aligning torque reference value calculating method comprising the steps of:
estimating self aligning torque applied to a tire;
estimating a slip angle of the tire;
calculating a self aligning torque model value using the estimated slip angle;
calculating a self aligning torque ratio which is a ratio between the estimated self aligning torque and the calculated self aligning torque model value; and
calculating a self aligning torque reference value based on the self aligning torque ratio and the self aligning torque model value when a maximum value of the calculated self aligning torque ratio exceeds a threshold value.

9. A road surface friction state estimating method comprising:
estimating a self aligning torque applied to a tire;
estimating a slip angle of the tire;
calculating a self aligning torque model value using the slip angle estimated;
calculating a self aligning torque ratio which is a ratio between the self aligning torque estimated and the self aligning torque model value calculated;
calculating a self aligning torque reference value based on the self aligning torque ratio and the self aligning torque model value when a maximum value of the self aligning torque ratio calculated exceeds a threshold value; and
estimating a road surface friction state based on the self aligning torque estimated and the self aligning torque reference value calculated.
